(19) United States
(12) Patent Application Publication
(10) Pub. No.: US 2026/0370543 A1
(43) Pub. Date: Nov. 19, 2026

(54) METHOD AND DEVICE FOR DETECTING CROSSTALK FAULT, NETWORK SYSTEM AND COMPUTER STORAGE MEDIUM

(71) Applicant: ZTE CORPORATION, Shenzhen, Guangdong (CN)

(72) Inventors: Mingsheng LI, Guangdong (CN); Weiliang ZHANG, Shenzhen, Guangdong (CN)

(21) Appl. No.: 19/121,067

(22) PCT Filed: Jun. 7, 2023
(86) PCT No.: PCT/CN2023/098999

§ 371 Date: Apr. 14, 2025

(30) Foreign Application Priority Data
Oct. 18, 2022 (CN) 202211275996.8

(51) Int. Cl. H04L 41/0677; H04Q 11/00

(52) U.S. Cl. CPC H04L 41/0677; H04Q 11/0067; H04Q 2011/0049; H04Q 2011/0083; H04Q 2213/13521; H04Q 2213/13523

(57) ABSTRACT

The present application provides a method for detecting crosstalk fault of network bandwidth, including: capturing bandwidth allocation results of different channels in the network; and checking bandwidth allocation overlap situation of optical network units of different channels according to bandwidth allocation results of different channels captured, and obtaining a bandwidth crosstalk fault result of the network according to bit error situation on OLT side. The present application further provides a device for detecting crosstalk fault, a network system and a computer storage medium.

### CROSS-REFERENCE TO RELATED APPLICATIONS

The present application claims priority to Chinese Patent Application No. 202211275996.8, filed on Oct. 18, 2022. The disclosure of the above-mentioned application is incorporated herein by reference in its entirety.

### TECHNICAL FIELD

The present application relates to the technical field of network communication, and specifically to a method for detecting crosstalk fault of network bandwidth, a device for detecting crosstalk fault of network bandwidth, a network system and a computer storage medium.

### BACKGROUND

Currently, a large number of Gigabit-Capable PON (GPON) systems have been deployed in the FTTx market. With the upgrade of standards and the increase in user demand, GPON systems begins to gradually upgrade and evolve to XG(S)-PON (10-Gigabit Symmetric Passive Optical Network). GPON and XG(S)-PON coexist in a wavelength division mode, that is, the downstream wavelength of GPON and the downstream wavelength of XG(S)-PON are different, and the upstream wavelength of GPON and the upstream wavelength of XG(S)-PON are also different. During the upgrade and evolution process, GPON and XG(S)-PON may coexist in the same Optical Distribution Network (ODN), that is, the same ODN contains both GPON system and XG(S)-PON system.

In actual tests, it was found that the XG(S)-PON Optical Network Unit (ONU) affects the receiving sensitivity of the GPON Optical Line Terminal (OLT), resulting in bit errors. As shown in FIG. 4, the transmitted optical signal of the XG-PON ONU carries a relatively high power spectral density signal in the GPON band. In response to this, the standard organization proposed to limit the Out of Band Power Spectral Density (OOB PSD) of the XG(S)-PON ONU. However, the cost of the XG(S)-PON ONU needs to be increased, and due to the large number of ONU sides, the overall cost is high.

Therefore, it is necessary to propose a low-cost solution to the problem that the bit errors occur when receiving data on the OLT side.

### SUMMARY

In response to the above technical problems, the present application provides a method for detecting crosstalk fault of network bandwidth, a device for detecting crosstalk fault of network bandwidth, a network system and a computer storage medium, aiming to solve the problem that the bit errors occur when receiving data on the OLT side at a low cost.

In a first aspect, the present application provides a method for detecting crosstalk fault of network bandwidth, including:
capturing bandwidth allocation results of different channels in the network; and
checking bandwidth allocation overlap situation of optical network units of different channels according to bandwidth allocation results of different channels captured, and obtaining a bandwidth crosstalk fault result of the network according to bit error situation on a network terminal side.

The embodiment of the present application further provides a device for detecting crosstalk fault of network bandwidth, including:
a capture module, configured for capturing bandwidth allocation results of different channels in the network; and
a fault analysis module, configured for checking bandwidth allocation overlap situation of optical network units of different channels according to bandwidth allocation results of different channels captured, and obtaining a bandwidth crosstalk fault result of the network according to bit error situation on a network terminal side.

The embodiment of the present application further provides a network system, including a device for detecting crosstalk fault, the device for detecting the crosstalk fault includes a processor and a memory, the memory stores a program for detecting the crosstalk fault of network bandwidth, and the program is called by the processor and executes the above-mentioned method for detecting the crosstalk fault of any of the above embodiments.

The embodiment of the present application further provides a computer storage medium, storing a computer processing program, the computer processing program is called by a processor to execute the above-mentioned method for detecting the crosstalk fault of any of the above embodiments.

The embodiment of the present application analyzes the bandwidth allocation result by capturing the bandwidth allocation result of different channels during network transmission, so as to determine the situation of the crosstalk fault. Therefore, there is no need to modify the functions of the existing system, the implementation cost is low, the crosstalk fault can be quickly located, and the problem of bit error occurring when the OLT side receives data is solved.

### BRIEF DESCRIPTION OF THE DRAWINGS

The accompanying drawings herein are incorporated into the specification and constitute a part of the specification, showing embodiments consistent with the present application, and are used together with the specification to explain the principles of the present application. In order to more clearly illustrate the technical solutions of the embodiments of the present application, the accompanying drawings required for the description of the embodiments will be briefly introduced below. Obviously, for those skilled in the art, other accompanying drawings can be obtained based on these accompanying drawings without creative labor.

FIG. 1 is a flow chart of a method for detecting crosstalk fault of network bandwidth according to a first embodiment of the present application.

FIG. 2 is a flow chart of a method for detecting crosstalk fault of network bandwidth according to a second embodiment of the present application.

FIG. 3 is a functional module diagram of a device for detecting crosstalk fault of network bandwidth according to an embodiment of the present application.

FIG. 4 is a structural diagram of a network system related to the present application, and the network system includes an XG(S)-PON system and a GPON system.

The realization of the purpose, functional features and advantages of the present application will be further described in conjunction with the embodiments and with reference to the accompanying drawings. The above accompanying drawings have shown clear embodiments of the present application, which will be described in more detail later. These accompanying drawings and text descriptions are not intended to limit the scope of the present application in any way, but to illustrate the concept of the present application to those skilled in the art by referring to specific embodiments.

### DETAILED DESCRIPTION OF THE EMBODIMENTS

Exemplary embodiments will be described in detail herein, examples of which are shown in the accompanying drawings. When the following description refers to the accompanying drawings, unless otherwise indicated, the same numbers in different accompanying drawings represent the same or similar elements. The embodiments described in the following exemplary embodiments do not represent all embodiments consistent with the present application. Instead, they are only examples of devices and methods consistent with some aspects of the present application as detailed in the attached claims.

It should be noted that in the present application, the terms “include”, “comprise” or any other variant thereof are intended to cover non-exclusive inclusion, so that a process, method, article or device that includes a series of elements includes not only those elements, but also further includes other elements that are not explicitly listed, or further includes elements inherent to such process, method, article or device. In the absence of more restrictions, the elements defined by the sentence “include a . . . ” do not exclude the existence of other identical elements in the process, method, article or device including the element. In addition, the components, features and elements with the same name in different embodiments of the present application may have the same meaning or different meanings, and their specific meanings shall be determined by their interpretation in the specific embodiment or further combined with the context in the specific embodiment.

It should be understood that although the terms first, second, third, etc. may be used to describe various information in the present application, these information should not be limited to these terms. These terms are only used to distinguish the same type of information from each other. For example, the first information may also be referred to as the second information, and similarly, the second information may also be referred to as the first information, without departing from the scope of the present application. Depending on the context, the word “if” as used herein can be interpreted as “at . . . ” or “when . . . ” or “in response to determination”. Furthermore, as used in the present application, the singular forms “one”, “an” and “the” are intended to also include plural forms unless there is an indication to the contrary in the context. It should be further understood that the terms “comprises” and “includes” indicate the presence of the described features, steps, operations, elements, components, items, types, and/or groups, but do not exclude the presence, occurrence or addition of one or more other features, steps, operations, elements, components, items, types, and/or groups. The terms “or”, “and/or”, “including at least one of the following”, etc. used in the present application can be interpreted as inclusive, or mean any one or any combination. For example, “including at least one of the following: A, B, C” means “any of the following: A; B; C; A and B; A and C; B and C; A and B and C”, and for another example, “A, B or C” or “A, B and/or C” means “any of the following: A; B; C; A and B; A and C; B and C; A and B and C”. Exceptions to this definition only occur when the combination of elements, functions, steps or operations is inherently mutually exclusive in some way.

Although the steps in the flowchart in the embodiment of the present application are displayed in sequence as indicated by the arrows, these steps are not necessarily executed in sequence in the order indicated by the arrows. Unless otherwise specified herein, the execution of these steps is not strictly limited in order and may be executed in other orders. Moreover, at least a portion of the steps in the figure may include multiple sub-steps or multiple stages, which are not necessarily executed at the same time, but may be executed at different times, and the execution order is not necessarily sequential, but may be executed in turn or alternately with other steps or at least a portion of the sub-steps or stages of other steps.

Depending on the context, the words “if” and “in response to” as used herein may be interpreted as “at the time of” or “when” or “in response to determination” or “in response to detection”. Similarly, depending on the context, the phrases “if determining” or “if detecting (the stated condition or event)” may be interpreted as “when determining” or “in response to determine” or “when detecting (the stated condition or event) ” or “in response to detecting (the stated condition or event)”.

In the present application, step codes such as S10 and S20 are used for the purpose of more clearly and concisely describing the corresponding content, and do not constitute a substantial restriction on the order. When implementing the specific implementation, those skilled in the art may execute S20 first and then S10, etc., but these should be within the scope of the present application.

The specific embodiments described herein are only used to explain the present application and are not used to limit the present application.

In the subsequent description, the use of suffixes such as “module”, “component” or “unit” used to represent elements is only for the purpose of facilitating the description of the present application, and has no specific meaning in itself. Therefore, “modules”, “components” or “units” can be used in a mixed way.

In the process of upgrading GPON to XG(S)-PON, GPON and XG(S)-PON may coexist in the same Optical Distribution Network (ODN), that is, the same ODN contains both GPON and XG(S)-PON systems.

In actual use, there is a bandwidth overlap situation between the optical network unit of XG(S)-PON and the optical network unit of GPON, which causes the situation that crosstalk occurs when the two optical network units with overlapping bandwidth transmit signals at the same time. For this interference problem between different channels, the collaborative Dynamically Bandwidth Assignment (DBA) of GPON and XG(S)-PON is the best solution.

However, in the existing system, OLT dynamically allocates bandwidth according to the traffic situation of ONU, and the bandwidth map (BWmap) of each cycle (that is, the bandwidth allocation result) changes dynamically, that is, the bandwidth allocation result of GPON and the bandwidth allocation result of XG(S)-PON change dynamically over time. Therefore, at a certain moment, the bandwidth of the two ONUs that affect each other may overlap or may not overlap, and it is difficult to locate whether there is an OOB crosstalk fault between them. Moreover, since the system functions are fixed, it is impossible to implement functions such as OOB crosstalk fault location and avoidance by modifying the system functions.

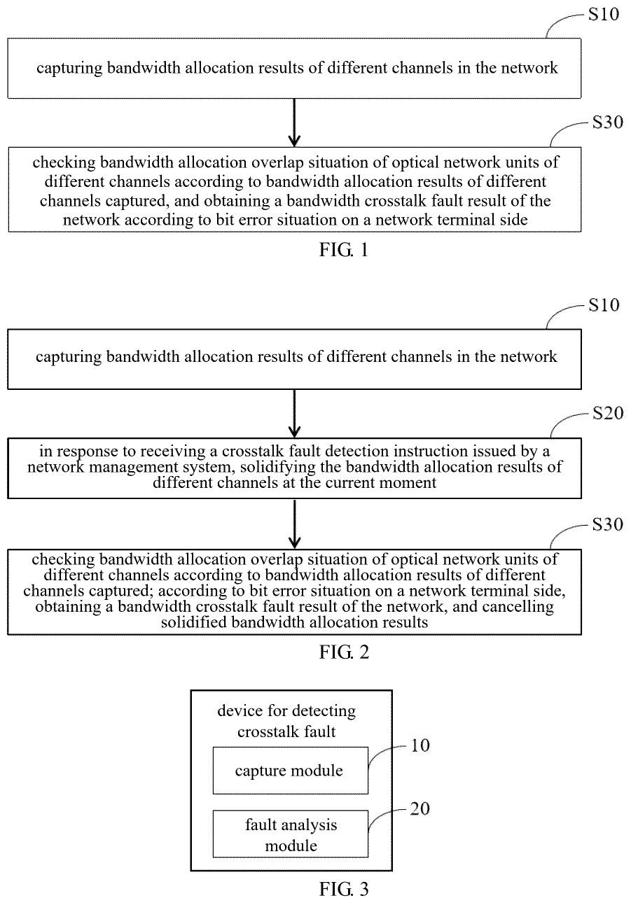

Therefore, the embodiment of the present application proposes a method for realizing OOB crosstalk positioning in an existing system. Referring to FIG. 1, the method for detecting crosstalk fault in the first embodiment of the present application includes:

S10, capturing bandwidth allocation results of different channels in the network.

In an embodiment, the capture of the bandwidth allocation result mentioned above has a variety of trigger modes. For example, receiving the crosstalk fault detection instruction issued by the network management system to trigger the capture of the bandwidth allocation result; or setting the time by a timer and regularly triggering the capture of the bandwidth allocation result. The network management system issues the crosstalk fault detection instruction, which can be issued when a bit error occurs in the received data on the network terminal side of the OLT network, or can be issued during routine maintenance and detection.

In an embodiment, the bandwidth allocation results of different channels in the network at current moment are captured in response to receiving a crosstalk fault detection instruction issued by a network management system, such as the bandwidth allocation results of different channels in GPON and XG(S)-PON systems. In an embodiment, the bandwidth allocation result includes a plurality of bandwidth entries, and these bandwidth entries are T-CONTs (transmission containers) allocated to the ONUs of the system. Each bandwidth entry includes a start time of the bandwidth allocation and an end time of the bandwidth allocation, or includes a start time of the bandwidth allocation and a time length of the bandwidth allocation, which are then converted into a start time and an end time.

In another embodiment, when capturing the bandwidth allocation results of different channels in the network at a fixed time, it can be that obtaining a situation where a bit error occurs in response to the network terminal side receiving data at the same time.

S30, checking bandwidth allocation overlap situation of optical network units of different channels according to bandwidth allocation results of different channels captured, and obtaining a bandwidth crosstalk fault result of the network according to bit error situation on a network terminal side.

In an embodiment, the bandwidth allocation results of different channels are analyzed, whether the bandwidth entries overlap in time sequence is determined, so as to define that there is bandwidth overlap between the optical network units corresponding to the overlapping bandwidth entries. The specific details are as follows.

In response to that a start time of bandwidth allocation of an optical network unit of a first channel is within a range of a start time of bandwidth allocation of an optical network unit of a second channel and an end time of the bandwidth allocation of the optical network unit of the second channel, or an end time of bandwidth allocation of an optical network unit of the first channel is within the range of the start time of the bandwidth allocation of the optical network unit of the second channel and the end time of the bandwidth allocation of the optical network unit of the second channel, determining that there is bandwidth overlap between the optical network unit of the first channel and the optical network unit of the second channel.

In response to that the start time of the bandwidth allocation of the optical network unit of the second channel is within a range of the start time of the bandwidth allocation of the optical network unit of the first channel and the end time of the bandwidth allocation of the optical network unit of the first channel, or the end time of the bandwidth allocation of the optical network unit of the second channel is within a range of the start time of the bandwidth allocation of the optical network unit of the first channel and the end time of the bandwidth allocation of the optical network unit of the first channel, determining that there is the bandwidth overlap between the optical network unit of the first channel and the optical network unit of the second channel.

After determining that there are optical network units with overlapping bandwidth, checking whether the bit error exists. If the bit error continues to exist, determining that the corresponding optical network unit is the crosstalk fault source. Taking a bit error occurring on the GPON OLT side as an example, determining that the ONU of XG(S)-PON has a bandwidth overlap with the ONU on the GPON OLT side, and determining the ONU as the crosstalk fault source.

In some embodiments, before determining bandwidth overlap, it is necessary to perform clock synchronization for different channels, so as to ensure that the bandwidth allocation time of different channels is based on the same beginning time, thereby ensuring the accuracy of the bandwidth overlap judgment.

The embodiment of the present application does not need to modify the functions of the existing system, but captures the bandwidth allocation result of different channels during network transmission, thereby analyzing the bandwidth allocation result and determining the crosstalk fault situation.

In an embodiment, when the crosstalk fault detection instruction issued by the network management system under the situation that bit error occurs in the data received at the network terminal OLT side contains bit errors, or the regularly captured data contains bit errors, the process that analyzing the bandwidth allocation result to determine the crosstalk fault situation is as follows.

Comparing the bandwidth allocation results of different channels captured according to time sequence, determining an optical network unit of other channel whose bandwidth overlaps with bandwidth of an optical network unit where the bit error occurs in the time sequence, and placing them in a fault source set with crosstalk fault.

If the bit error occurs when the GPON OLT side receives data, determining the bandwidth entry corresponding to the optical network unit where the bit error occurs from the bandwidth allocation result of the captured GPON OLT, which is referred to as the first bandwidth entry; then determining the second bandwidth entry that overlaps with the first bandwidth entry in time sequence from the bandwidth allocation result of the captured XG(S)-PON; finally, obtaining the optical network unit corresponding to the second bandwidth entry. If the bit error still exists, considering the optical network unit as an existing crosstalk fault source and placing it in the fault source set of the crosstalk fault.

In another embodiment, when the network management system issues a crosstalk fault detection instruction during routine maintenance, at this time, no bit error occurs when the network terminal OLT receives data or no bit error occurs in the regularly captured data, the process of analyzing the bandwidth allocation result to determine the crosstalk fault situation is as follows.

Comparing the bandwidth allocation results of different channels captured according to time sequence, determining an optical network unit whose bandwidth overlaps in time sequence, and placing them in a set without crosstalk fault.

Specifically, if no bit error occurs on the GPON OLT side, determining the optical network unit corresponding to the bandwidth entry that does not overlap in time sequence from the captured bandwidth allocation result of GPON OLT and the bandwidth allocation result of XG(S)-PON. If no bit error occurs, determining that there is no OOB crosstalk fault, and placing the optical network unit in the set without crosstalk fault, thereby narrowing the scope of the optical network unit with potential OOB crosstalk, and providing strong support for the subsequent rapid location of OOB crosstalk fault.

Referring to FIG. 2, based on the crosstalk fault method of the first embodiment of the present application, the method for detecting crosstalk fault of the second embodiment of the present application further includes:

S20, in response to receiving a crosstalk fault detection instruction issued by a network management system, solidifying the bandwidth allocation results of different channels at the current moment, until obtaining bandwidth crosstalk fault situation of the network, cancelling solidified bandwidth allocation results.

In a specific embodiment, when requiring the crosstalk fault detection, the network management system will send commands to each coexisting system, such as the GPON OLT and XG(S)-PON system, so that each system solidifies the bandwidth allocation result at the current moment, that is, each system stops performing the bandwidth allocation result and continues to send the current bandwidth allocation result. After analyzing and obtaining the network's bandwidth crosstalk fault situation based on the fixed bandwidth allocation result, cancelling the fixed bandwidth allocation result, and each system can perform normal bandwidth allocation.

The embodiment of the present application can more accurately detect the crosstalk fault situation by solidifying the bandwidth allocation result.

Based on the above embodiment, the method for detecting crosstalk fault in the third embodiment of the present application further includes the following.

Storing obtained bandwidth allocation results and situation that bit errors occur in response to receiving data on the network terminal side, to allow to analyze and obtain bandwidth crosstalk fault situation of the network subsequently based on stored information.

In the above embodiment, after capturing the bandwidth allocation result, the situation that the bit error occurs when the network terminal side receives data can be obtained at the same time, and the bandwidth allocation result and the bit error situation can be stored together. When necessary, the stored information can be retrieved to analyze the bandwidth allocation result and determine the OOB crosstalk fault situation.

The embodiment of the present application stores the bandwidth allocation result and the bit error situation, thereby realizing the flexibility of crosstalk fault detection. For example, the crosstalk fault detection can be performed at an appropriate time as needed, or the crosstalk fault detection can be performed offline.

The above embodiment can be applied to the OOB crosstalk fault detection between GPON ONU and XG(S)-PON ONU, the OOB crosstalk fault detection between different upstream channels, and the OOB crosstalk fault detection processing can also be performed with reference to the embodiment of the present application, which will not be repeated.

The above embodiment can include the following application scenarios when applied specifically.

### The First Application Example

When a bit error occurs when the GPON OLT side receives the ONU upstream data, reporting the bit error event to the network management system. The operation and maintenance personnel can send commands to the GPON and XG(S)-PON systems by the network management system to solidify the bandwidth allocation result of GPON and XG(S)-PON, that is, GPON and XG(S)-PON stop updating the bandwidth allocation result and continue to send the current bandwidth allocation result. Certainly, the network management system can also automatically trigger and send commands according to the bit error event.

Reading the current BWmap of GPON and BWmap of XG(S)-PON, and comparing in time sequence, including: determining the bandwidth entries corresponding to the GPON ONU occurring bit error, determining the bandwidth entries corresponding to the XG(S)-PON ONUs that overlap with these bandwidth entries in time sequence, and checking which ONU the T-CONT of these bandwidth entries belongs to. Under the situation that the bit error still exists, listing these XG(S)-PON ONUs as the source of generating the OOB crosstalk fault. Then cancelling the fixed BWmap and continuing the normal bandwidth allocation process. Repeating this process, and gradually narrowing the range of XG(S)-PON ONUs that generate OOB crosstalk faults, and even determining the only XG(S)-PON ONU.

In this implementation, when a bit error occurs, by solidifying BWmap and checking the bandwidth allocation overlap situation, and timely detecting two ONUs that generate OOB crosstalk faults with each other, so that the operation and maintenance personnel can further take engineering measures to eliminate and avoid OOB crosstalk faults.

In this implementation, the OOB crosstalk of XG(S)-PON ONU to GPON ONU is taken as an example; in fact, the OOB crosstalk processing of GPON ONU to XG(S)-PON ONU is similar and will not be repeated.

### The Second Application Example

In daily maintenance and detection, generally, no bit error in reception at the OLT side. At this time, the operation and maintenance personnel can also send commands to GPON OLT and XG(S)-PON OLT by the network management system to solidify the bandwidth allocation result of GPON OLT and XG(S)-PON OLT, and check the XG(S)-PON ONU and GPON ONU with bandwidth overlap currently; under the situation that confirming that no bit error occur, determining that there is no OOB crosstalk failure between these ONUs, and putting these ONUs into the set without crosstalk faults.

This implementation is used in daily maintenance and detection. By solidifying BWmap, checking the bandwidth allocation overlap situation and no bit error situation, determining which ONUs do not have OOB crosstalk faults, so as to narrow the scope of potential OOB crosstalk fault ONUs, and provide strong support for the subsequent rapid location of OOB crosstalk faults.

In this implementation, the OOB crosstalk between the XG(S)-PON ONU and the GPON ONU is taken as an example; in fact, the OOB crosstalk processing between the GPON ONU and the XG(S)-PON ONU is similar and will not be repeated.

### The Third Application Example

The network management system can initiate the OOB crosstalk fault detection process at an appropriate time to solidify the BWmap of the GPON OLT and XG(S)-PON OLT, for example, when a bit error is detected on the GPON OLT side, or when it is required for routine detection.

Determining whether a bit error is detected on the GPON OLT or XG(S)-PON OLT side. If the bit error is detected on the GPON OLT or XG(S)-PON OLT side, determining the ONU where the bit error occurs, and checking the bandwidth entries of the ONUs that overlap with the bandwidth entry of the ONU in time sequence. These ONUs are temporarily listed as OOB crosstalk fault sources, and are comprehensively processed with the previous OOB crosstalk fault source and the crosstalk fault set without OOB crosstalk fault, and the OOB crosstalk fault source is updated. Cancelling the BWmap solidification, continuing normal bandwidth allocation, and continuing to solidify the BWmap as needed.

If no bit error is detected on the GPON OLT or XG(S)-PON OLT side, checking the ONUs with overlapping bandwidth entries that have overlapping time sequences, no OOB crosstalk fault exists between these ONUs, and updating the crosstalk fault set. Cancelling the BWmap solidification, continuing the normal bandwidth allocation, and continuing to solidify the BWmap as needed.

### The Fourth Application Example

During the network transmission process, it can simultaneously obtain the bandwidth allocation result of the GPON OLT, the bandwidth allocation result of the XG(S)-PON, the situation of bit error received at the GPON OLT side, and the situation of bit error received at the XG(S)-PON OLT side. Then, it can obtain this information at a specific time, and aiming at this information, it can perform real-time analysis of the OOB crosstalk fault situation, or can store firstly for subsequent offline analysis of the OOB crosstalk fault situation.

The above examples are only reference examples. In order to avoid redundancy, they are not listed one by one here. In actual development or application, they can be flexibly combined according to actual needs, but any combination belongs to the technical solution of the present application and is covered within the scope of the present application.

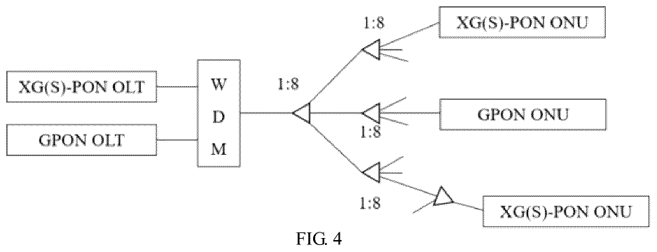

Referring to FIG. 4, the embodiment of the present application further provides a device for detecting crosstalk fault including: a capture module 10 and a fault analysis module The capture module 10 is configured for capturing bandwidth allocation results of different channels in the network.

The fault analysis module 20 is configured for checking bandwidth allocation overlap situation of optical network units of different channels according to bandwidth allocation results of different channels captured, and obtaining a bandwidth crosstalk fault result of the network according to bit error situation on a network terminal side.

This embodiment implements the principle of crosstalk fault detection between different channels of the network bandwidth, referring to the above embodiments, which will not be repeated here.

The present application further provides a network system, the network system includes various coexisting subsystems and a device for detecting crosstalk fault. The device for detecting crosstalk fault includes a memory and a processor, and the memory stores a processing program. When the processing program is executed by the processor, the method for detecting crosstalk fault in any of the above embodiments is implemented.

The present application further provides a computer-readable storage medium, the storage medium stores a processing program, and when the processing program is executed by the processor, the method for detecting crosstalk fault in any of the above embodiments are implemented.

In the embodiments of the network system and computer-readable storage medium provided in the present application, all technical features of any of the above processing method embodiments may be included, and the description expansion and explanation content are basically the same as the embodiments of the above methods, and will not be repeated here.

The embodiment of the present application further provides a computer program product, which includes a computer program code. When the computer program code runs on a computer, the computer executes the method in the above various possible implementations.

It can be understood that the above scenario is only an example and does not constitute a limitation on the application scenario of the technical solution provided in the embodiment of the present application. The technical solution of the present application can also be applied to other scenarios. For example, it is known to those skilled in the art that with the evolution of the system architecture and the emergence of new business scenarios, the technical solution provided in the embodiment of the present application is also applicable to similar technical problems.

The serial number of the above embodiment of the present application is only for description and does not represent the advantages and disadvantages of the embodiment.

The steps in the method of the embodiment of the present application can be adjusted in sequence, merged and deleted according to actual needs.

The units in the device of the embodiment of the present application can be merged, divided and deleted according to actual needs.

In the present application, for the same or similar terminology, technical solutions and/or application scenario descriptions, they are generally only described in detail when they appear for the first time; when they appear again later, they are generally not repeated for the sake of brevity. When understanding the technical solutions and other contents of the present application, for the same or similar terminology, technical solutions and/or application scenario descriptions that are not described in detail later, it can refer to the previous relevant detailed descriptions.

In the present application, the descriptions of each embodiment have their own emphasis. For the parts that are not described or recorded in detail in a certain embodiment, it can refer to the relevant descriptions of other embodiments.

The various technical features of the technical solution of the present application can be combined arbitrarily. In order to make the description concise, all possible combinations of the various technical features in the above embodiments are not described. However, as long as there is no contradiction in the combination of these technical features, they should be considered to be within the scope of the present application.

By the description of the above implementation methods, those skilled in the art can clearly understand that the above-mentioned embodiment method can be implemented by means of software plus the necessary general hardware platform, and certainly can also be implemented by hardware, but in many situations the former is a better implementation mode. Based on this understanding, the technical solution of the present application, or the part that contributes to the prior art, can be embodied in the form of a software product, which is stored in a storage medium (such as ROM/RAM, disk, CD) as above, including several instructions to enable a terminal device (which can be a mobile phone, computer, server, controlled terminal, or network device, etc.) to execute the method of each embodiment of the present application.

In the above embodiments, it can be implemented in whole or in part by software, hardware, firmware or any combination thereof. When implemented by software, it can be implemented in whole or in part in the form of a computer program product. The computer program product includes one or more computer instructions. When the computer program instructions are loaded and executed on the computer, the process or function according to the embodiment of the present application is generated in whole or in part. The computer can be a general-purpose computer, a special-purpose computer, a computer network, or other programmable device. Computer instructions can be stored in a computer-readable storage medium, or transmitted from a computer-readable storage medium to another computer-readable storage medium. For example, computer instructions can be transmitted from one website, computer, server or data center to another website, computer, server or data center by wired (e.g., coaxial cable, optical fiber, digital subscriber line) or wireless (e.g., infrared, wireless, microwave, etc.) means. Computer-readable storage media can be any available medium that can be accessed by a computer or a data storage device such as a server or data center that includes one or more available media integrated. Available media can be magnetic media (e.g., floppy disks, storage disks, tapes), optical media (e.g., DVDs), or semiconductor media (e.g., solid-state storage disks Solid State Disk (SSD)), etc.

The above are only some embodiments of the present application, and do not limit the scope of the present application. Any equivalent structure or equivalent process transformation made using the contents of the present application's specification and drawings, or directly or indirectly applied in other related technical fields, are also included in the scope of the present application.

1. A method for detecting crosstalk fault of network bandwidth, comprising:
capturing bandwidth allocation results of different channels in the network; and
checking bandwidth allocation overlap situation of optical network units of different channels according to bandwidth allocation results of different channels captured, and obtaining a bandwidth crosstalk fault result of the network according to bit error situation on a network terminal side.

2. The method for detecting the crosstalk fault according to claim 1, wherein the capturing bandwidth allocation results of different channels in the network comprises:
in response to receiving a crosstalk fault detection instruction issued by a network management system, capturing the bandwidth allocation results of different channels in the network at current moment.

3. The method for detecting the crosstalk fault according to claim 1, wherein the capturing bandwidth allocation results of different channels in the network comprises: capturing the bandwidth allocation results of different channels in the network at a fixed time;
the method for detecting the crosstalk fault of bandwidth further comprises: obtaining a situation where a bit error occurs in response to the network terminal side receiving data.

4. The method for detecting the crosstalk fault according to claim 2, wherein the checking the bandwidth allocation overlap situation of the optical network units of different channels according to the bandwidth allocation results of different channels captured, and obtaining the bandwidth crosstalk fault result of the network according to the bit error situation on the network terminal side comprises:
in response to that the bit error occurs, comparing the bandwidth allocation results of different channels captured according to time sequence, determining an optical network unit of other channel whose bandwidth overlaps with bandwidth of an optical network unit where the bit error occurs in the time sequence, and placing them in a fault source set with crosstalk fault.

5. The method for detecting the crosstalk fault according to claim 2, wherein the checking the bandwidth allocation overlap situation of the optical network units of different channels according to the bandwidth allocation results of different channels captured, and obtaining the bandwidth crosstalk fault result of the network according to the bit error situation on the network terminal side comprises:
in response to that no bit error occurs, comparing the bandwidth allocation results of different channels captured according to time sequence, determining an optical network unit whose bandwidth overlaps in time sequence, and placing them in a set without crosstalk fault.

6. The method for detecting the crosstalk fault according to claim 1, wherein the bandwidth allocation result comprises a start time of bandwidth allocation and an end time of the bandwidth allocation; the method for detecting crosstalk fault of the bandwidth further comprises:
in response to that a start time of bandwidth allocation of an optical network unit of a first channel is within a range of a start time of bandwidth allocation of an optical network unit of a second channel and an end time of the bandwidth allocation of the optical network unit of the second channel, or an end time of bandwidth allocation of an optical network unit of the first channel is within the range of the start time of the bandwidth allocation of the optical network unit of the second channel and the end time of the bandwidth allocation of the optical network unit of the second channel, determining that there is bandwidth overlap between the optical network unit of the first channel and the optical network unit of the second channel; and
in response to that the start time of the bandwidth allocation of the optical network unit of the second channel is within a range of the start time of the bandwidth allocation of the optical network unit of the first channel and the end time of the bandwidth allocation of the optical network unit of the first channel, or the end time of the bandwidth allocation of the optical network unit of the second channel is within a range of the start time of the bandwidth allocation of the optical network unit of the first channel and the end time of the bandwidth allocation of the optical network unit of the first channel, determining that there is the bandwidth overlap between the optical network unit of the first channel and the optical network unit of the second channel.

7. The method for detecting the crosstalk fault according to claim 1, further comprising:
in response to receiving a crosstalk fault detection instruction issued by a network management system, solidifying the bandwidth allocation results of different channels at the current moment, until obtaining bandwidth crosstalk fault situation of the network, cancelling solidified bandwidth allocation results.

8. The method for detecting the crosstalk fault according to claim 1, further comprising:
storing obtained bandwidth allocation results and situation that bit errors occur in response to receiving data on the network terminal side, to analyze and obtain bandwidth crosstalk fault situation of the network subsequently based on stored information.

9. A device for detecting crosstalk fault of network bandwidth, comprising:
a capture module, configured for capturing bandwidth allocation results of different channels in the network; and
a fault analysis module, configured for checking bandwidth allocation overlap situation of optical network units of different channels according to bandwidth allocation results of different channels captured, and obtaining a bandwidth crosstalk fault result of the network according to bit error situation on a network terminal side.

10. A network system, comprising a device for detecting crosstalk fault, wherein the device for detecting the crosstalk fault comprises a processor and a memory, the memory stores a program for detecting the crosstalk fault of network bandwidth, and the program is called by the processor and executes the method for detecting the crosstalk fault according to claim 1.

11. A non-transitory computer storage medium, storing a computer processing program, wherein the non-transitory computer processing program is called by a processor to execute the method for detecting the crosstalk fault according to claim 1.
